(19) United States
(12) Patent Application Publication
(10) Pub. No.: US 2007/0002736 A1
(43) Pub. Date: Jan. 4, 2007

(54) System and method for improving network resource utilization

(75) Inventors: Anuradha Gade, Saratoga, CA (US); Bruce McMurdo, San Jose, CA (US); Jeremy Stieglitz, Menlo Park, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/154,204

(22) Filed: Jun. 16, 2005

(51) Int. Cl. H04L 12/26

(52) U.S. Cl. 370/230; 726/23

(57) ABSTRACT

A system for improving network resource utilization. The system includes a prioritizer that prioritizes received data by assigning one or more priority values thereto. A network resource monitor provides network resource information. A transmitter selectively transmits the data based on the network resource information and the one or more priority values. In a specific embodiment, the data includes network messages, and the prioritizer includes a prioritization mechanism that assigns a priority value to each of the network messages. A threshold-comparison mechanism compares each of the priority values to a threshold and provides comparison results in response thereto. The transmitter selectively transmits each of the network messages based on the comparison results. In an illustrative embodiment, the network messages include network alerts generated by an Intrusion Detection System (IDS).

### BACKGROUND OF THE INVENTION

This invention is related in general to processing of digital information and more specifically to systems and methods for selectively affecting data traffic in a network.

Systems for monitoring and selectively affecting network traffic are employed in various demanding applications including firewalls and Wireless Intrusion Detection Systems (WIDS) for wireless networks. Such applications demand efficient traffic-monitoring systems that perform certain functions, such as generating alarms in response to unauthorized communications, without excessively burdening network resources.

Efficient traffic-monitoring systems are particularly important for networks employing WIDS. WIDS often improve network security by facilitating thwarting Denial-Of-Service (DOS) network attacks, preventing unauthorized clients or access points (rogue systems) from consuming network resources, and so on. Conventionally, when a WIDS detects security concerns, corresponding alerts are automatically forwarded to a network controller for processing. Unfortunately, WIDS data traffic, such as alerts, may congest associated networks.

To reduce network congestion caused by WIDS data traffic, WIDS customers must often disable various WIDS services or augment network resources, such as by increasing network bandwidth at traffic bottlenecks, disabling the WIDS or other services, or by installing separate WIDS management systems at strategic network locations, such as at network branches or dedicated Local Area Network (LAN) switches. Unfortunately, such network modifications are often prohibitively expensive or otherwise undesirable.

### BRIEF DESCRIPTION OF THE DRAWINGS

FIG. 1 is a diagram illustrating an embodiment of the present invention adapted for use with a network.

FIG. 2 is a flow diagram of a first method implemented via the embodiment of FIG. 1 during a first mode of operation.

FIG. 3 is a flow diagram of a second method implemented via the embodiment of FIG. 1 during a second mode of operation.

### DETAILED DESCRIPTION OF EMBODIMENTS OF THE INVENTION

A preferred embodiment of the present invention implements a system for improving network resource utilization. The system includes a prioritizer that prioritizes received data by assigning one or more priority values thereto. A network resource monitor provides network resource information. A transmitter selectively transmits the data based on the network resource information and the one or more priority values. In general, any type of hardware or software or combination thereof can be used with aspects of the invention. Any type of network or communication link can be used. Furthermore, any type of data, such as Intrusion Detection System (IDS) alerts, may be used with aspects of the invention.

For clarity, various well-known components, such as power supplies, communications ports, routers, gateways, firewalls, and so on, have been omitted from the figures. However, those skilled in the art with access to the present teachings will know which components to implement and how to implement them to meet the needs of a given application.

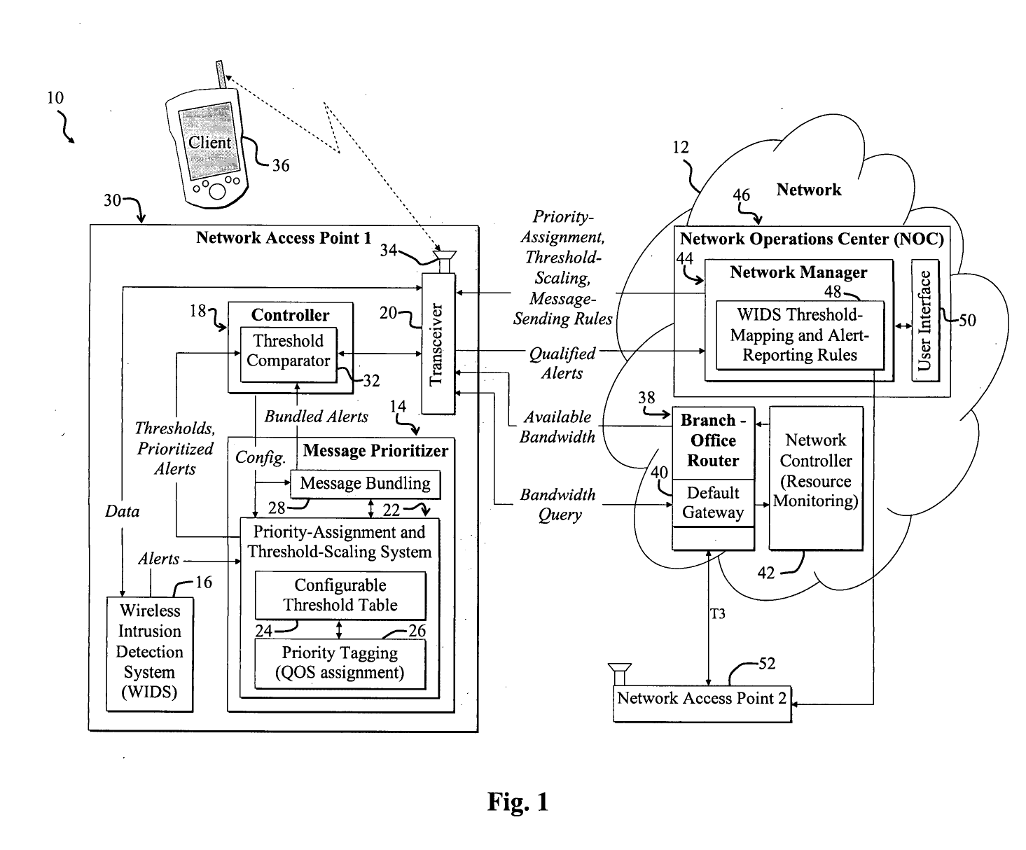

FIG. 1 is a diagram illustrating an embodiment 10 of the present invention adapted for use with a network 12. The embodiment 10 is a specific illustrative embodiment of a system for improving network resource utilization. In the present embodiment, the system 10 includes a message prioritizer 14 in communication with a Wireless Intrusion Detection System (WIDS) 16 and a controller 18 running on a first network access point 30. The WIDS 16 communicates with the controller 18 and a transceiver 20, which also communicates with the controller 18.

The message prioritizer 14 includes message bundler 28 and a priority-assignment and threshold-scaling system 22, which includes a configurable threshold table 24 in communication with a priority tagging module 26, which acts as a QOS-assignment mechanism. The priority-assignment and threshold-scaling system 22 receives alert inputs from the WIDS 16 and selectively provides prioritized alerts and corresponding thresholds to a threshold comparator 32 and/or the message bundler 28 running on the controller 18 and message prioritizer 14, respectively. The threshold-scaling system 22 and the message bundler 28 receive configuration parameters from the controller 18. The configuration parameters may affect message flow between the priority-assignment and threshold-scaling system 22, the message bundler 28, and the threshold comparator 32.

The WIDS 16 receives data from the transceiver 20, which includes an antenna 34 for receiving wireless communications from a client, such as a wirelessly enabled computer 36. In the present embodiment, the transceiver 32 also communicates with the network 12 via a branch-office router 38, which includes a default gateway 40. The first network access point 30 communicates with a network controller 42 via the default gateway 40.

The first network access point 30 also employs the transceiver 20 to communicate with a network manager 44 running on a Network Operations Center (NOC) 46. The NOC 46 further includes a WIDS threshold-mapping and alert-reporting module 48 that maintains threshold-mapping and alert-reporting rules for governing the behavior of the message prioritizer 14 and the threshold comparator 32 of the first network access point 30. A user interface 50 communicates with the threshold-mapping and alert-reporting module 48. The user interface 50 enables a user to observe and make changes to threshold-mapping and alert-reporting rules and may further enable viewing of alert reports as discussed more fully below. The user interface 50 acts as a priority-adjustment mechanism that adjusts priority rules employed by the message prioritizer 14, as discussed more fully below.

In the present embodiment, the NOC 46 is shown connected directly to the transceiver 20 of the first network access point 30. However, those skilled in the art will appreciate that intervening routers, switches, and so on, such as the branch office router 38 may be employed to facilitate communications between the NOC 46 and the network access point 30.

For illustrative purposes, a second network access point 52 communicates directly with the network manager 44 of the NOC 46 and with the network controller 42 via the default gateway 40 and a high-speed T3 link. The NOC 46 may be implemented via the network controller 42 without departing from the scope of the present invention.

In operation, various clients, such as the wireless client 36, communicate with the network 12 via network access points 30, 52. The WIDS 16 monitors communications between the client 36 and the network access point, searching for signs of unauthorized or otherwise undesirable communications. Undesirable communications include communications from unassociated clients, ad hoc network broadcasts, and so on. Other indications of unauthorized communications include Message Integrity Code (MIC) failures, clients or nodes reporting similar Media Access Control (MAC) addresses, and so on. When the WIDS 16 detects unauthorized or undesirable communications or signs thereof, the WIDS 16 generates one or more corresponding alerts. The alerts are messages containing information pertaining to what condition triggered the alert.

The WIDS 16 may be located or otherwise include components that are located in places other than the first network access point 30. For example, the WIDS 16 may be implemented via software running on the network controller 42, the NOC 46, the first network access point 30, and/or the second network access point 52 without departing from the scope of the present invention. Note that various currently available WIDS may be readily used with or adapted for use with embodiments of the present invention without departing from the scope thereof and without undue experimentation.

Alerts are forwarded by the WIDS 16 to the priority-assignment and threshold-scaling system 22, where each alert is assigned a priority value and/or a Quality-of-Service (QOS) value. In the present specific embodiment, the configuration table 24 maintains a listing of alert types, priorities to be associated with teach type of alert, and a current alert threshold level to be compared with alert priority values. Multiple thresholds for each type or category of alert and/or a single global threshold to be compared to priority values of all alerts may be employed without departing from the scope of the present invention.

The access point controller 18 may employ the configurable threshold table 24 to determine if currently available network resources, i.e., the current bandwidth setting of the network controller 42 necessitates distribution of alerts to the network controller 42 and/or the NOC 46. Alerts may be logged via the message bundler 28 for future distribution, such as if a network connection is down. Configuration settings controlling whether alerts are discarded, logged, or sent may be configured via the user interface 50 and/or via user interface of the controller 18 of the network access point 30 of FIG. 1.

When the priority-assignment and threshold-scaling system 22 receives an alert from the WIDS 16, the system 22 references the configurable threshold table 24 to determine the appropriate priority value to assign to the alert and the appropriate threshold to be compared to the priority. The resulting alert priority value and corresponding threshold are forwarded to the threshold comparator 32 running on the controller 18. The threshold comparator 32 then compares the alert priority with the corresponding threshold. If the alert priority value surpasses the threshold, then the alert is forwarded to the network manager 44 and/or controller 42 for further handling.

In the present embodiment, the one or more thresholds employed by the priority-assignment and threshold-scaling system 22 are dynamic thresholds, which are updated based on network resource information that specifies currently available network resources, such as network bandwidth available to the first network access point 30. The controller 18 runs software to periodically query the network controller 42 for the network information. Queries are sent to the network controller 42 via the default gateway 40 of the branch-office router 38. The network controller 42 responds to the queries by forwarding requested network resource information, such as available bandwidth, to the controller 18 of the first network access point 30 via the branch office router 38 and transceiver 20. Hence, in the present embodiment, one of the functions of the controller 18 includes acting as a network resource monitor.

The network resource information is forwarded to the message prioritizer 14, which scales the thresholds stored in the configurable threshold table 24 accordingly. For example, when network resources are low, the thresholds maintained in the configurable threshold table 24 are increased, thereby allowing fewer alerts to be forwarded via the network 12. Similarly, significant network resources are available, threshold values stored in the configurable threshold table 24 are lowered by the message prioritizer 14, thereby enabling more alerts to be sent over the network 12.

The priority-tagging module 26 may tag each incoming alert with a QOS value. The QOS value may be incorporated with the alert message itself. The network manager 44 and/or other network components may selectively handle alerts based on QOS values assigned thereto, as discussed more fully below.

Unlike priority values associated with each received alert message, QOS values are incorporated within each alert message rather than just associated therewith. Consequently, when the tagged alert is forwarded via the network 12, the QOS values may be employed to prioritize alert handling. For example, the network manager 44 and/or the network controller 42 via the network 12 may process alerts with higher QOS values before alerts with lower QOS values. Hence, the present embodiment 10 can tag IDS alerts with different QOS settings to ensure that the most severe alerts have higher priority through the network 12.

Alternatively, the QOS values may also act as priority values, which the threshold comparator 32 compares to one or more dynamic thresholds that scale in accordance with available network resources. In such implementations, priority values that are not incorporated within the alerts themselves may be omitted without departing from the scope of the present invention.

Hence, alerts are forwarded via the network 12 based on their priority and available network resources, such as bandwidth. This prevents flooding the network with low priority alerts when the network 12 is busy. Furthermore, alert processing may be adjusted in response to QOS values assigned to each alert so that relatively low priority messages are not processed before higher priority messages. Accordingly, various aspects of embodiments of the present invention may improve network-bandwidth and processor-resource utilization.

An administrator may employ the user interface 50 to adjust priority-value assignment rules, i.e., to adjust which priority values are assigned to which types of alerts; to adjust relationships between threshold levels and available network resources, such as bandwidth, e.g., to affect how threshold levels are scaled according to network resources; to adjust or set rules specifying whether messages are sent or grouped by the message prioritizer 14 and specifying how they are grouped; and so on. For example, in the present embodiment, an administrator may employ the user interface 50 to adjust the operational mode of the message prioritizer 14 so that alerts are categorized, bundled, and sent when network resources or other conditions are favorable. In this mode, the message bundler 28 receives prioritized alerts and corresponding thresholds from the priority-assignment and threshold-scaling system 22 and groups them according to priority. For example, alerts associated with priority values between a first range may be assigned to a yellow group, while alerts associated with priority values between as second lower range may be assigned to a red group, while alerts associated with a third even lower range may be assigned to a green group. The mapping rules 48 maintained by the network manager 44 running on the NOC 46 and changeable by an administrator via the user interface 50 may specify that, for example, green alerts (alerts assigned to the green group) be archived and only transferred via the network 12 in response to a request by the network manager 44; that red alerts be sent every hour; and that yellow alerts be sent every minute. In this mode, times between sending of groups of alerts may be dynamically adjusted based on current network conditions.

Alternatively, in this mode, the timing of alert sending is not adjusted based on dynamically changing available network resources but rather based on predetermined time intervals based solely on message priority level. Alternatively, timing of alert sending may be adjusted based on fixed network link information. For example, the mapping rules 48 maintained by the network manager 44 may specify that alerts generated at the second network access point 52, which maintains a high-speed T3 connection to the network 12, be sent more frequently than alerts generated at the first network access point 30, which maintains a slower, i.e., lower-bandwidth connection to the network 12 than the second network access point 52.

Whether the system 10 operates according to a first mode, wherein individual alerts are analyzed and sent based on their priority values, or according to a second mode, wherein messages are bundled before sending, reports may be constructed via software running on the network manager 44 and then displayed via the user interface 50.

An administrator operating the user-interface 50 or another interface, such as one incorporated within the network controller 42, may adjust mapping thresholds associated with the configurable threshold table 24 for each network access point 30, 52. Furthermore, the user interface 50 may include a dashboard display indicating all WIDS alerts received from network entities, such as the network access points 30, 52. The display may organize alerts according to priority to facilitate handling by the administrator or other network manager. Furthermore, software running on the network manager 44 or other entity may generate batch IDS reports based on network utilization. Alternatively, such reports may be generated by software, such as the controller 18, running on the network access point 30 and then forwarded to the appropriate controller 42 or NOC 46 instead of streaming multiple alerts through the network 12. Batch reports may be sent at optimal times as determined via the access point controller 18 with reference to current network bandwidth settings or other indications of available network resources. For example, lower priority alerts that were not sent due to bandwidth conditions may be grouped for sending when sufficient network bandwidth becomes available.

In some implementations, alerts requiring relatively high-order network visibility are not assigned access-point specific priorities by the message prioritizer 14. Instead, assigned priorities account for overall network priority, which may be determined by the network manager 44. Alternatively, the access point controller 18 may simply forward alerts requiring certain network visibility without comparing the alerts to specific thresholds. Alert classification and/or priority-assignment rules 48, implemented via the priority assignment module 22 and/or the message bundler 28, for categorizing such high-visibility alerts, could be adjusted so that classification or priority assignment by one network access point 30 will not affect the visibility of the alert.

In a preferred embodiment, the mapping rules 48 specify that the operational mode of the system 10 be automatically adjusted based on network conditions, such as available network resources. For example, when available network resources are minimal, the mapping rules 48 may adjust the message prioritizer 14 and controller 18 to operate according to the second operational mode. In the second operational mode, messages may be bundled for sending at future times when network resources permit.

Hence, various operational modes of the system 10 enable metering of WIDS traffic based on alert priority. In certain implementations or modes, threshold levels may be employed to categorize alerts to determine when the alerts should be sent. Various modules employed to implement embodiments of the present invention may be readily developed in software or hardware are by those skilled in the art and without undue experimentation.

In addition to or instead of employing thresholds that are compared to alert priorities to determine whether alerts are sent, the system 10 may employ thresholds to classify or group alert priorities. For example, alerts associated with priority values between two particular threshold values may be assigned a group priority value, such as red, yellow, or green.

Those skilled in the art will appreciate that various methods for determining available network resources may be employed to implement embodiments of the present invention without departing from the scope thereof. Furthermore, the term available network resources may represent any indication of the condition of the network. In one embodiment, the available network resources represent the network bandwidth available to the network controller 42, which may be a Wide Area Network (WAN) controller. The network bandwidth available may be obtained by the access point controller 18 in response to a query forwarded to the network controller 42 requesting the current controller-bandwidth setting from the network controller 42. The bandwidth setting of the network controller 42 affects which severity levels/thresholds must be exceeded for the network controller 42 to receive the alerts from the network access point 30.

Hence, the system 10 may improve network security by improving network bandwidth utilization while facilitating preventing rogue access points from being connected to the network 12. The user-interface 50 and accompanying network manager 44 facilitate providing greater visibility to network managers of various threats and priorities of the threats, such as of over-the-air wireless network security and DOS attack threats.

Embodiments of the present invention are particularly useful in Wireless Local Area Network (WLAN) applications. One method, which may be implemented via the system 10, includes the following steps:

1. The access point 30 detects new IDS alarm on an accompanying scanning or data-serving channel.

2. The access point 30 determines the severity of the alarm (e.g. “red”, “yellow” or “green”).

3. If necessary, the access point 30 determines the network bandwidth available for use by the WLAN controller 42 over the WAN 12.

4. Using the configurable table 24, the access point 30 determines if present network-bandwidth setting requires IDS alert distribution to controller system 42. (e.g. if >2 k, send yellow alerts, if >1 k send red alerts, if <1 log.) In an exemplary schema, the access point 30 may consider any IDS alert associated with rogue access points, unassociated clients, or ad-hoc network broadcasts to be “red”, and any MIC failure events, two 802.11 nodes with the same media-access-control address, etc. to be yellow. In fact, the system 10 tag various IDS alerts with different QOS settings via the priority-tagging module 26, to better ensure that the most severe alerts have high priority status through the WAN.

5. If the access point 30 is unable to detect any network connection (e.g. network outage), additional configuration settings 48 can set whether to discard and/or log alerts for future distribution. The access point 30 can accumulate all the WIDS alerts and then send a summarized version when the link is restored.

6. The wireless network manager application 44, which is deployed in the central NOC 46, can be used to define WIDS threshold mapping rules 48. An administrator can employ the user interface 50 to create site-profiles and specify WIDS mapping rules 48 for various sites, i.e., access points 30,52. For example, the first access point 30 can be configured to send WIDS alerts based on available bandwidth, while the second access point 52, with a T3 link, may provide more regular WIDS updates in real time. Wireless network manager 44 can provide a WIDS dashboard via the user interface 50 that consolidates all WIDS alerts from various access points 30, 52 and then display them in priority order, such as red, yellow, green.

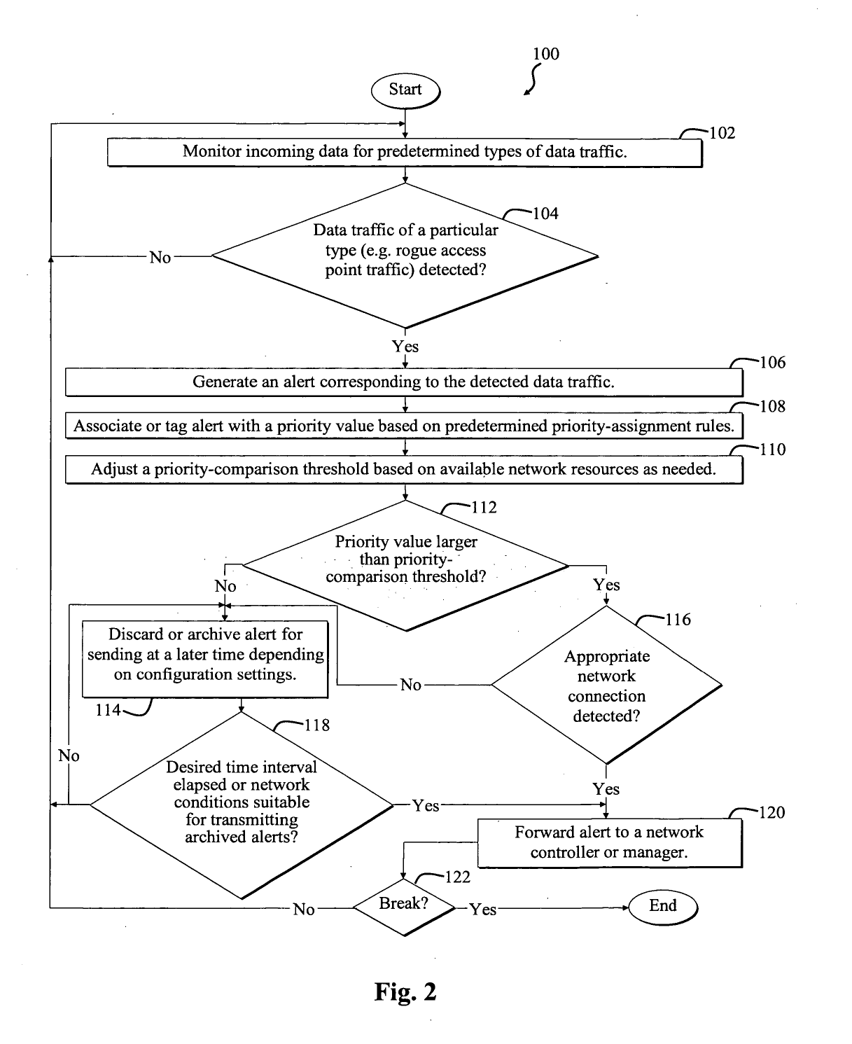

FIG. 2 is a flow diagram of a first method 100 implemented via the embodiment 10 of FIG. 1 during a first mode of operation. With reference to FIGS. 1 and 2, the method 100 includes an initial monitoring step 102, wherein incoming data, such as data from the client 36, is monitored for predetermined types of data traffic, such as traffic corresponding to rogue access points, unauthorized clients, DOS attack messages, and so on. In the embodiment of FIG. 1, the WIDS 16 monitors traffic associated with the client 36. If the incoming traffic represents data of the predetermined type(s) as verified by a first decision step 104, then an alert-generating step 106 is performed next. Otherwise, the monitoring step 102 continues.

The alert-generating step 106, which is performed by the WIDS 16 of FIG. 1, involves generating an alert corresponding to the data traffic detected in the monitoring step 102. For example, if a message from a rogue client is detected, the WIDS 16 generates an alert associated with the message.

In a subsequent tagging step 108, the generated alert is tagged or otherwise associated with a priority value, such as a QOS value or other priority value, by the priority-assignment and threshold-scaling system 22. Priority assignments are performed according to predetermined user-configurable assignment rules 48, which are reflected in the configuration table 24. An additional user-interface associated with the first access point 30 may be employed to change threshold and/or priority values maintained by the configurable threshold table 24.

In a subsequent threshold-adjusting step 110, one or more threshold values maintained by the configuration table 24 are adjusted based on available-bandwidth information obtained by the message prioritizer 14 in response to queries sent to the network controller 42 by the access-point controller 18. For example, a global threshold may increase as network resources drop and decrease as network resources rise. The configurable threshold table 24 may implement routines to automatically scale threshold values according to available network resources, such as bandwidth, and according to configuration parameters received from the network manager 44 via the access-point controller 18.

In a subsequent threshold-comparing step 112, the threshold comparator 32 compares the priority value associated with the alert that was generated in the alert-generating step 106 with a corresponding threshold stored in the configurable threshold table 24. If the priority value is less than or otherwise compares unfavorably to the associated threshold, then a message-archiving step 114 is performed next. Otherwise, a connection-detecting step 116 is performed.

The message-archiving step 114 involves discarding or archiving the alert. The alert is not sufficiently prioritized to warrant sending through the network 12 for processing by the network controller 42 or manager 44. After the alert is deleted or archived, a subsequent timing step 118 is implemented as needed.

The timing step 118 may involve sending bundled or archived messages at later times, such as when more network resources are available and when the priorities of the archived messages compare favorably to the current thresholds. Particular operational details may be adjusted via configuration settings forwarded by the access point controller 18 to the message prioritizer 14 and accompanying message bundler 28. In the present embodiment, if a desired time interval has elapsed or network conditions have become favorable for transmitting the archived alert(s), then an alert-forwarding step 120 is performed. Otherwise, the monitoring step 102 is performed, and the archiving step 114 continues, wherein the alerts remain archived until conditions become favorable. In this embodiment, the access point controller 30 in communication with the network controller 42 act as a timing mechanism for determining optimal times to send or discard alerts based on bandwidth capabilities of the network access point 30 and/or other available network resources, such as the current bandwidth setting established at the network controller 42.

The alert-forwarding step 120 involves forwarding the alert and/or corresponding group of similarly prioritized alerts to the network controller 42 or network manager 44 for further processing.

A subsequent break-checking step 122 determines if software and/or hardware controlling the method 100 is disabled or otherwise turned off. Then the method 100 ends. Otherwise, the method 100 continues, and the initial monitoring step 102 is performed again.

If in the threshold-comparing step 112, the priority of the detected alert surpasses or otherwise compares favorably to the associated threshold, then the connection-detecting step 116 is performed. The connection-detecting step involves determining if the communications link between the first network access point 30 and the network 12 is established or otherwise up.

For the purposes of the present discussion, the terms network resource information and available network resources may include information indicating when a particular network link or connection is operable or inoperable, i.e., is up or not. If the network connection is up, then the alert-forwarding step is performed next. Otherwise, the message-archiving step 114 is performed next, wherein the alert is held until network conditions are favorable for transmitting the alert as determined by the timing step 118.

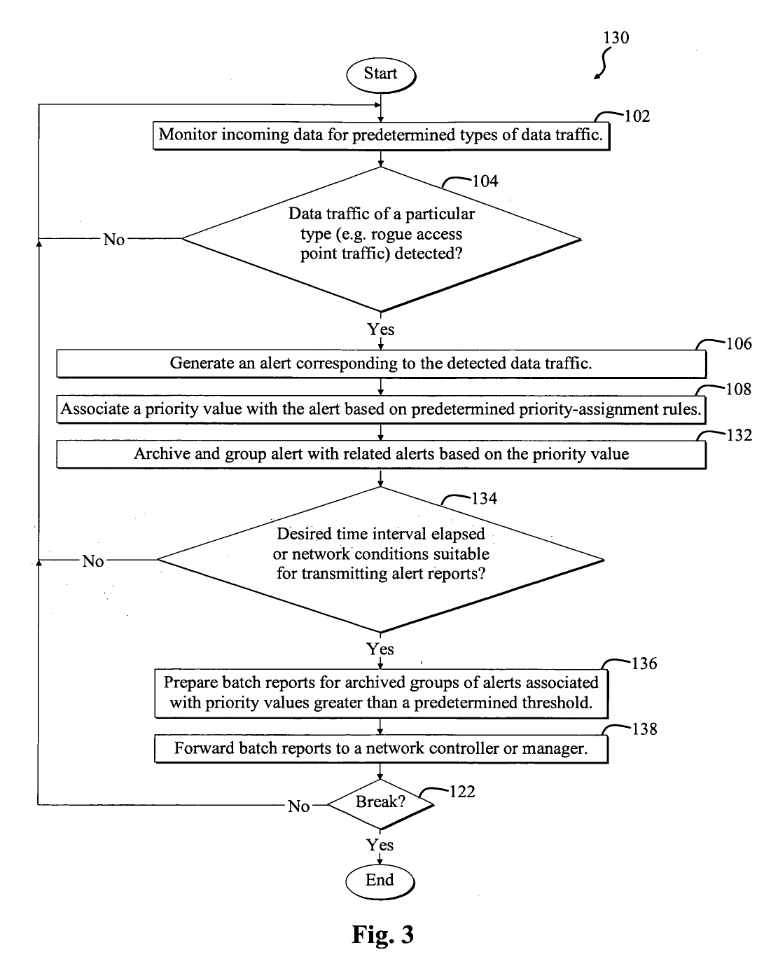

FIG. 3 is a flow diagram of an alternative method 130 implemented via the embodiment of FIG. 1 during a second mode of operation. With reference to FIGS. 1-3, the first four steps 102-108 of the method 130 are similar to the first four steps 102-108 of the method 100 of FIG. 2. After the tagging step 108, the alternative method 130 includes an alert-grouping step 132. The alert-grouping step 132 involves grouping and/or archiving alerts based on priority values assigned to the alerts via the tagging step 108.

In a subsequent report-decision-making step 134, the system 10 of FIG. 1 determines if a desired time interval has elapsed and/or whether network conditions are suitable for transmitting reports based on the alerts that were archived and/or grouped via the alert-grouping step 132. If the desired time interval has not elapsed and/or conditions are not favorable for sending alert reports, then alert monitoring and collecting continues as implemented via steps 102-108 and step 132 of FIG. 3. Otherwise, a batch-reporting step 136 is performed 136.

The batch-reporting step 136 involves generating batch reports for groups of alerts associated with priority values greater than a predetermined threshold. Alternatively, batch reports are generated for all groups of messages in preparation for sending at desired time intervals as determined by a subsequent report-forwarding step 138. In the present embodiment, alert-reports forwarded to the network controller 42 or network manager 44 of FIG. 1 in the report-forwarding step 138. Subsequently, if a system break is detected in the break-checking step 122, then the method 130 completes. Otherwise, the initial monitoring step 102 of the alternative method 130 continues.

Various steps of the methods 100 and 130 may be omitted, modified, or interchanged without departing from the scope of the present invention. Furthermore, the system 10 of FIG. 1 may implement the methods 100, 130, and/or other related methods without departing from the scope of the present invention. User-configurable configuration parameters maintained by the network manager 44, the access-point controller 18, and/or other modules, may determine whether the system 10 of FIG. 1 performs the method 100 of FIG. 2 in a first mode of operation and/or performs the alternative method 130 of FIG. 3 in a second mode of operation.

While in certain embodiments disclosed herein, thresholds are scaled based on available network resources, priority values assigned to different types of alerts may be scaled instead without departing from the scope of the present invention. For example, with reference to FIG. 1, the priority-assignment and threshold-scaling system 22 may adjust priority values in the configurable threshold table 24 in stead of the corresponding thresholds in response to network resource information received from the network controller 42.

While the present embodiment is discussed with reference to WIDS-alert handling, embodiments of the present invention are not limited thereto. For example, many types of network data other than network alerts may benefit from prioritizing data and sending the data based on available network bandwidth in accordance with embodiments of the present invention. By employing novel methods that may include assigning priority values to data and comparing the priority values to resources that scale with available network resources, embodiments of the present invention facilitate improving and/or optimizing network resource utilization.

In other embodiments, network messages other than WIDS alerts may be prioritized and selectively sent via a network based on available network resources, such as available bandwidth, without departing from the scope of the present invention. Examples of other types of network messages, communications or operations that may be suitable for bandwidth throttling can include radio management and performance, location beaconing, device roaming, and client association messages. In general, any bandwidth-impacting or network-resource-impacting events may be handled similarly to the WIDS events described herein in detail without departing from the scope of the present invention.

Variations and embodiments other than those discussed herein are possible. For example, embodiments employing the Internet or other packet switched networks and embodiments employing video calls, file transfers, conference calls, and so on are possible.

Although embodiments of the invention are discussed primarily with respect to server-client architecture, any acceptable architecture, topology, protocols, or other network and digital processing features can be employed. In general, network controllers, managers, access points, clients, and so on, can be implemented via any device with processing ability or other requisite functionality. It is also possible that functionality relevant to embodiments of the present invention can be included in a router, switch or device other than the first network access point 30 and network operations center 46 of FIG. 1.

Although processes of the present invention, and the hardware executing the processes, may be characterized by language common to a discussion of the Internet (e.g., “client,” “server,” “peer”) it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a client and server program, can be executing in a single machine, or in different machines. A single program can be operating as a client for one information transaction and as a server for a different information transaction.

Any type of processing device can be used as a client. For example, portable computing devices such as a personal digital assistant (PDA), cell phone, laptop computer, or other devices can be employed. In general, the devices and manner of specific processing (including location and timing) are not critical to practicing important features of the present invention.

Although embodiments of the present invention are discussed primarily with respect to IDSs and associated alerts transferred over a network, such as the Internet, any suitable network, network topology, transmission protocols, sender-receiver devices and relationships, and other characteristics or properties of electronic devices, processes and transmission methods can be used. For example, features of the invention can be employed on various scales and in various applications, including local area networks (LANs), campus or corporate networks, home networks, etc.

Although the invention has been discussed with respect to specific embodiments thereof, these embodiments are merely illustrative, and not restrictive, of the invention. Embodiments of the present invention can operate between any two processes or entities including users, devices, functional systems or combinations of hardware and software. Peer-to-peer networks and any other networks or systems where the roles of client and server are switched, change dynamically, or are not even present are within the scope of the invention.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A system for improving network utilization by controlling when messages are sent via a network comprising;
first means for prioritizing network messages;
second means for employing message prioritization to determine when the network messages should be sent via the network and providing a signal in response thereto; and
third means for selectively sending the network messages in response to the signal.

2. The system of claim 1 wherein the second means includes
means for monitoring available network resources and adjusting one or more thresholds in response thereto.

3. The system of claim 2 further including
means for comparing priority values assigned to the messages by the first means to the one or more thresholds and providing the signal in response thereto.

4. The system of claim 1 wherein the second means includes
means for adjusting times at which the network messages are sent by the third means based on priority values associated with each of the network messages.

5. The system of claim 4 wherein the second means further includes
means for bundling network messages according to message priority and sending resulting message bundles at times based on the message priority.

6. The system of claim 5 wherein the times based on the message priority represent times at which one or more corresponding message priority values exceed(s) a threshold, the threshold based on network capabilities.

7. The system of claim 1 wherein the second means includes
means for adjusting one or more priority values assigned to the messages via the first means based on the available network resources.

8. A system for improving network resource utilization comprising:
a first module capable of providing data;
a prioritizer adapted to prioritize the data by assigning one or more priority values thereto;
a network resource monitor that provides network resource information pertaining to available resources of the network; and
a transmitter that selectively transmits the data based on the network resource information and the one or more priority values.

9. The system of claim 8 wherein the data includes
network messages.

10. The system of claim 9 wherein the prioritizer includes
a prioritization mechanism that assigns a priority value to each of the network messages.

11. The system of claim 10 further including
a threshold-comparison mechanism that compares each of the priority values to a threshold and provides comparison results in response thereto, the transmitter selectively transmitting each of the network messages based on the comparison results.

12. The system of claim 11 wherein the network messages include
network alerts generated by an Intrusion Detection System (IDS).

13. The system of claim 12 wherein the network includes
one or more wireless network components, and wherein the IDS is a Wireless IDS (WIDS).

14. The system of claim 11 further including
a threshold-scaling system that selectively scales the thresholds based on available network resources.

15. The system of claim 14 wherein the threshold-scaling system includes
a configurable table, wherein network resources are associated with threshold values.

16. The system of claim 15 wherein the threshold-scaling system is accessible by a controller in communication with the transmitter.

17. The system of claim 15 wherein the priority values include
discrete classifications to enable the prioritizer to group each of the network messages according to message priority.

18. The system of claim 14 wherein the message prioritizer and an accompanying controller and the transmitter operate in accordance with predetermined operational modes.

19. The system of claim 18 wherein the predetermined operational modes are automatically adjustable in accordance with predetermined rules based on available network resources.

20. The system of claim 18 further including
a priority-adjustment mechanism that adjusts priority rules employed by the prioritizer to assign priority values to the network messages.

21. The system of claim 20 wherein the priority-adjustment mechanism includes
a user interface that enables a user to change the priority rules.

22. The system of claim 18 wherein the predetermined operational modes include
a first mode wherein network messages are transmitted, discarded, or archived immediately in response to the comparison results.

23. The system of claim 22 wherein the predetermined operational modes include
a second mode wherein transmission of one or more of the network messages is selectively delayed.

24. The system of claim 23 wherein when the system is operating according to the second operational mode, each of the network messages are bundled according to message priority and sent at optimal times or discarded based on the network resource information and the message priority.

25. The system of claim 24 further including
a timing mechanism for determining the optimal times based on capabilities of an associated network access point.

26. The system of claim 25 wherein the timing mechanism is adapted to adjust intervals between the optimal times based on bandwidth capabilities associated with the network access point.

27. The system of claim 24 wherein the network resource information includes
network operational state information, including information indicating when a particular network link is operable or inoperable.

28. The system of claim 23 wherein the first module, the prioritizer, the network resource monitor, and the transmitter are implemented at a network access point and/or a network manager or controller.

29. The system of claim 18 wherein the prioritizer includes
a Quality Of Service (QOS) assignment mechanism that incorporates QOS values within each of the network messages, the QOS values being based on the priority values.

30. The system of claim 29 further including
a network manager adapted to selectively handle each network message based on each corresponding QOS value.

31. A system for strategically affecting flow of network messages comprising:
first means for associating one or more of the network messages with one or more priority values;
second means for comparing the one or more priority values to threshold values representative of network bandwidth and providing a signal in response thereto; and
third means for selectively transmitting or routing one or more of the network messages corresponding to the one or more threshold values in response to the signal.

32. The system of claim 31 wherein the one or more network messages include
Intrusion Detection System (IDS) Alerts.

33. The system of claim 32 wherein the system includes
one or more modules running on an access point, a switch, and/or a local controller.

34. The system of claim 33 wherein the access point is a wireless access point.

35. The system of claim 31 wherein the first means includes
means fourth means for categorizing each of the network messages based on the priority values.

36. The system of claim 35 further including
fifth means for periodically determining currently available network bandwidth and selectively sending or relaying network messages via the network based on categorization of the network messages performed by the fourth means and based on the currently available network bandwidth.

37. A method for improving network resource utilization comprising:
providing data;
prioritizing the data by assigning one or more priority values thereto;
providing network resource information pertaining to available resources of the network; and
selectively transmitting the data via the network based on the network resource information and the one or more priority values.
